(19) United States
(12) Patent Application Publication
(10) Pub. No.: US 2026/0081825 A1
(43) Pub. Date: Mar. 19, 2026

(54) HIGH EFFICIENCY AND ON DEMAND COMPUTATIONAL ENVIRONMENTS FOR 5G NETWORK FUNCTIONS

(71) Applicant: DISH Wireless L.L.C., Littleton, CO (US)

(72) Inventors: Sundeep Goswami, Leesburg, VA (US); Dhaval Mehta, Aldie, VA (US); Gurpreet Sohi, Parker, CO (US)

(21) Appl. No.: 18/887,761

(22) Filed: Sep. 17, 2024

(51) Int. Cl. H04L 41/0806; H04L 41/12

(52) U.S. Cl. CPC H04L 41/0806; H04L 41/12

(57) ABSTRACT

The disclosed technology includes determining, based at least in part on a first set of properties, a first group of network functions; determining, based at least in part on the second set of properties, a second group of network functions; instantiating the first group of network functions on one or more of compute instances of a first set of compute instances, the first set of compute instances characterized at least in part by the first set of properties; instantiating the second group of network functions on one or more of the compute instances of a second set of compute instances, the second set of compute instances characterized at least in part by the second set of properties; and providing 5G cellular service to a user equipment using at least some of the first group of network functions and the second group of network functions.

### BACKGROUND

Computing systems required to provide functionality within 5G networks may be limited in many regards. Computing resources may be configured in a monolithic way, which may not allow for the intelligent use of computational resources, increasing costs and decreasing the quality of the network.

### BRIEF SUMMARY

A computing system may include a first set of compute instances, the first set of compute instances characterized at least in part by a first set of properties. The system may include a second set of compute instances, the second set of compute instances characterized at least in part by a second set of properties. The system may include one or more processors and a computer-readable medium may including instructions that, when executed by the one or more processors, cause the system perform operations. Accordingly, the system may determine, based at least in part on the first set of properties, a first group of network functions, used to implement a 5G cellular network. The system may determine, based at least in part on the second set of properties, a second group of network functions used to implement the 5G cellular network. The system may instantiate the first group of network functions on one or more of the compute instances of the first set of compute instances. The system may instantiate the second group of network functions on one or more of the compute instances of the second set of compute instances. The system may provide 5G cellular service to a user equipment using at least some of the first group of network functions and the second group of network functions.

In some embodiments, the first set of properties and the second set of properties may include at least one of a processor type, processing speed, or memory amount. The first set of compute instances may be configured to execute processor-heavy network functions. The second set of compute instances may be configured to execute high-throughput network functions. The first set of compute instances and the second set of compute instances may be implemented on a cloud based architecture. At least one of the first group of network functions or the second group of network functions may include a control function. The first group of network functions may include an active function implemented on a first compute instance of the first set of compute instances, and a backup function implemented on a second compute instance of the first set of compute instances.

A method for providing 5G cellular network may include determining, based at least in part on a first set of properties, a first group of network functions, used to implement a 5G cellular network. The method may include determining, based at least in part on a second set of properties, a second group of network functions used to implement the 5G cellular network. The method may include instantiating the first group of network functions on one or more of compute instances of a first set of compute instances, the first set of compute instances characterized at least in part by the first set of properties. The method may include instantiating the second group of network functions on one or more of the compute instances of a second set of compute instances, the second set of compute instances characterized at least in part by the second set of properties. The method may include providing 5G cellular service to a user equipment using at least some of the first group of network functions and the second group of network functions.

In some embodiments, the first set of properties and the second set of properties may include at least one of a processor type, processing speed, or memory amount. The first set of compute instances may be configured to execute processor-heavy network functions. The second set of compute instances may be configured to execute high-throughput network functions. The first set of compute instances and the second set of compute instances may be implemented on a cloud based architecture. The 5G cellular network is a standalone cellular network. At least one of the first group of network functions or the second group of network functions may include a control function. The first group of network functions may include an active function implemented on a first compute instance of the first set of compute instances and a backup function implemented on a second compute instance of the first set of compute instances.

A non-transitory computer-readable medium containing instructions, that when executed by one or more processors, cause the one or more processors to perform operations.

The operations may include determining, based at least in part on a first set of properties, a first group of network functions, used to implement a 5G cellular network; determining, based at least in part on a second set of properties, a second group of network functions used to implement the gG cellular network. The operations may include instantiating the first group of network functions on one or more of compute instances of a first set of compute instances, the first set of compute instances characterized at least in part by the first set of properties. The operations may include instantiating the second group of network functions on one or more of the compute instances of a second set of compute instances, the second set of compute instances characterized at least in part by the second set of properties. The operations may include providing 5G cellular service to a user equipment using at least some of the first group of network functions and the second group of network functions.

In some embodiments, the first set of properties and the second set of properties may include at least one of a processor type, processing speed, or memory amount. The first set of compute instances may be configured to execute processor-heavy network functions. The second set of compute instances may be configured to execute high-throughput network functions.

### BRIEF DESCRIPTION OF THE DRAWINGS

FIG. 1A illustrates an embodiment of a cellular network system, according to certain embodiments of the present invention.

FIG. 1B illustrates an exemplary core, according to certain embodiments of the present invention.

FIG. 2 illustrates an embodiment of a cellular network core network topology as implemented on a public cloud-computing platform, according to certain embodiments of the present invention.

FIGS. 3A-3C illustrates a computing system as implemented on a an embodiment of a cellular network core network topology as implemented on a public cloud-computing platform, according to certain embodiments of the present invention.

FIG. 4 depicts an example method according to certain embodiments of the disclosed technology.

FIG. 5 is a schematic of an example computer system according to certain embodiments of the disclosed technology.

### DETAILED DESCRIPTION

### Overview

Aspects of the disclosed technology provide for separation of groups of network functions related to 5G functionality within a computational system. The groups of network functions may be instantiated and uninstantiated within the computational system depending on the demands placed on the 5G network. Other properties of the computational system, the functions, and/or the 5G network may be utilized to determine groupings. Dynamic scaling of instances of network functions groups allows for functions most relevant to a current condition to be available with a higher availability, increasing the overall performance of the computing system and the 5G network.

As one example, such as during instances where there are many users in a concentrated geographical area, there may be many requests being received by the 5G network from user equipment in that concentrated geographical area. Yet each request may not require much data (e.g., low throughput during multiple voice calls) but may require low latency. Other requests may require high amounts of data but may not require low latency (e.g., downloading a video by a few users in an area).

In the above described, and other examples, the disclosed technology may allow for improved performance of systems, lower latency, dynamic provision of additional network functions, better matching of computational resources to requirements of a network, higher computational efficiency, etc.

### Example Systems and Methods

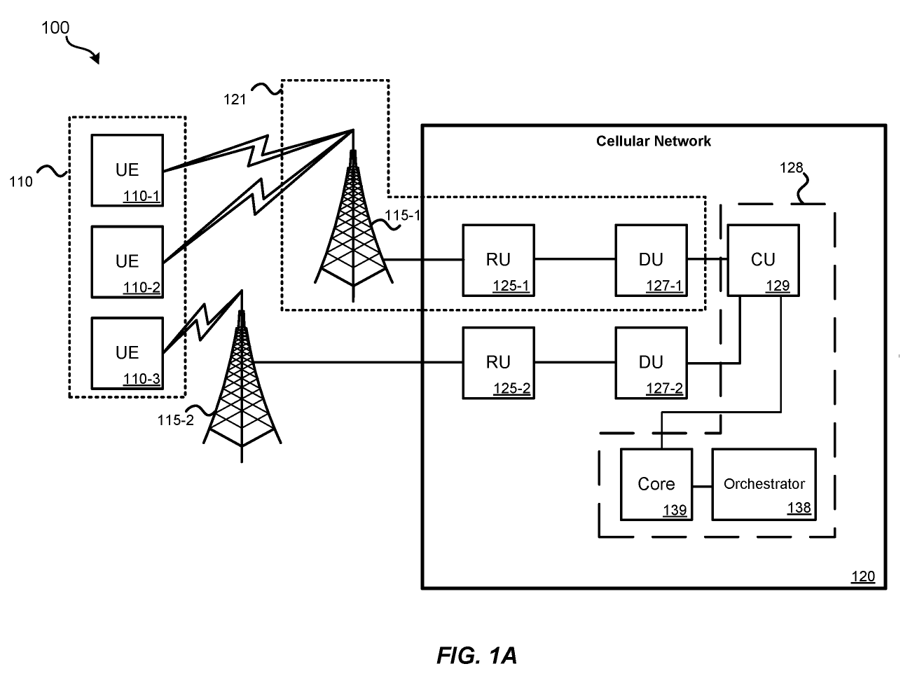

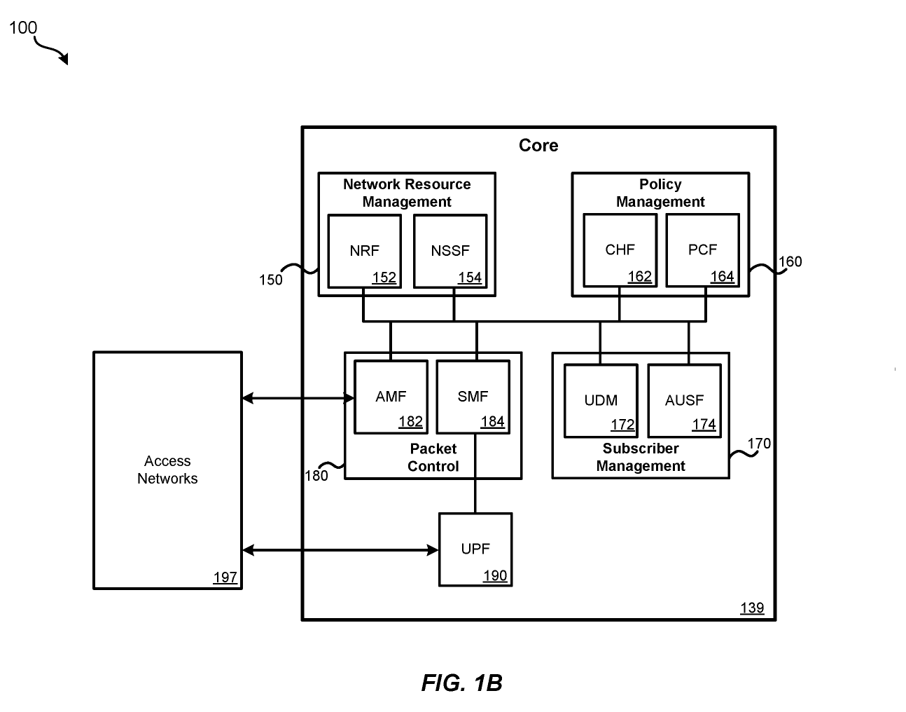

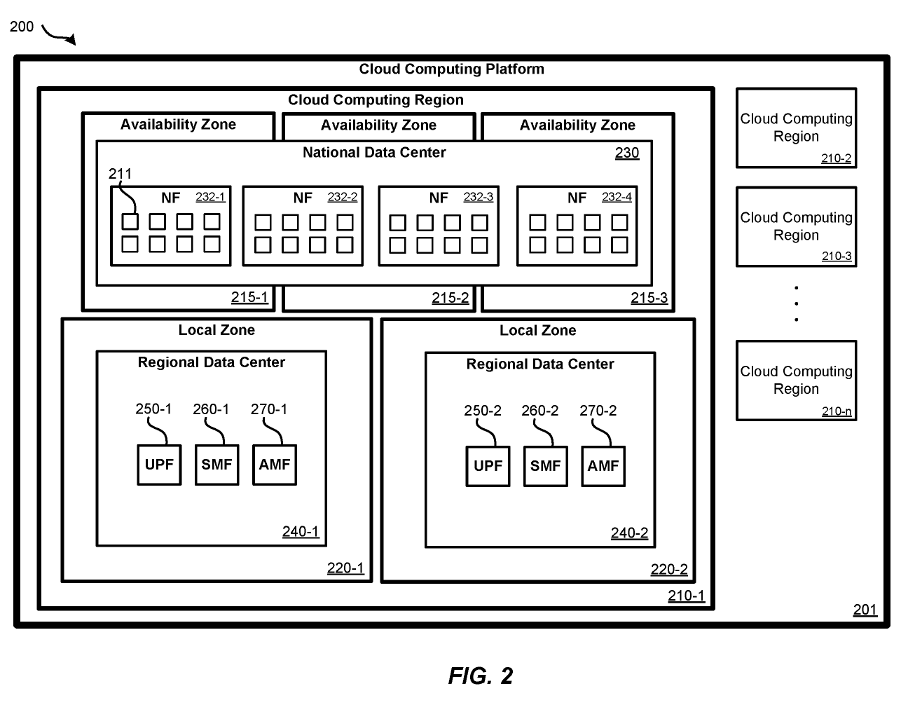

FIG. 1A illustrates an embodiment of a cellular network system 100 (“system 100”), according to certain embodiments. System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, and orchestrator 138. FIG. 1A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 2.

UE 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 110 may use RF to communicate with various base stations of cellular network 120. Two base stations 115 (BS 115-1, 115-2) are illustrated. Real-world implementations of system 100 can include many (e.g., hundreds, thousands) base stations, and many RUs, DUs, and CUs. BS 115 can include one or more antennas that allow RUs 125 (e.g., RU 125-1 and RU 125-2) to communicate wirelessly with UEs 110. RUs 125 can represent an edge of cellular network 120 where data is transitioned to wireless communication. In some implementations, the radio access technology (RAT) used by RU 125 is 5G New Radio (NR). Other implementations use other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 139 is provided in relation to FIG. 1B.

FIG. 1B illustrates an exemplary core 139, according to certain embodiments. The exemplary core 139 can be physically distributed across data centers or located at a central national data center (NDC), such as detailed in relation to FIG. 2, can perform various core functions of the cellular network. Core 139 can include: network resource management components 150; policy management components 160; subscriber management components 170; and packet control components 180. Individual components may communicate via a bus, thus allowing various components of core 139 to communicate with each other directly. Core 139 is simplified to show some key components. Implementations can involve additional components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE (e.g., UEs 110 of FIG. 1A).

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UEs.

Packet control components 180 can include: Access and Mobility Management Function (AMF) 182 and Session Management Function (SMF) 184. AMF 182 can receive connection- and session-related information from UEs and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, quality of service (QoS) handling, and external PDU sessions for interconnecting with a Data Network (DN) (e.g., the Internet) or various access networks 197. Access networks 197 can include the RAN of cellular network 120 of FIG. 1A.

While FIGS. 1A and 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

Returning to FIG. 1A, some O-RAN implementations of the DUs 127, CU 129, core 139, and/or orchestrator 138 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity’s data.

Kubernetes, or some other container orchestration platform, can be used to create and destroy the logical DU, CU, or 5G core units and subunits, as needed, for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1; and a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1A, UE 110 may be operating on one or more production slices of cellular network 120. As detailed later in this document, a UE that functions on a particular entity’s local network may be assigned to a slice particular to the entity or a slice that provides a particular QoE for tasks to be performed by the entity’s UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 2 illustrates an embodiment of a cellular network core network topology 200 as implemented on a public cloud-computing platform, according to certain embodiments. The cellular network core network topology 200 can be an implementation of the core 139 of FIG. 1A and/or FIG. 1B. Cellular network core network topology 200 can represent how logical cellular network groups are distributed across cloud computing infrastructure of cloud computing platform 201. Cloud computing platform 201 can be logically and physically divided up into various different cloud computing regions 210. Each of cloud computing regions 210 can be isolated from other cloud computing regions to help provide fault tolerance, fail-over, load-balancing, and/or stability and each of cloud computing regions 210 can be composed of multiple availability zones, each of which can be a separate data center located in general proximity to each other (e.g., within 600 miles). Further, each of cloud computing regions 210 may provide superior service to a particular geographic region based on physical proximity. For example, cloud computing region 210-1 may have its datacenters and hardware located in the northeast of the United States while cloud computing region 210-2 may have its datacenters and hardware located in California. For simplicity, the details of the cellular network as executed in only cloud computing region 210-1 is illustrated. Similar components may be executed in other cloud computing regions of cloud computing regions 210 (210-2, 210-3, 210-n).

In other embodiments, cloud computing platform 201 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 210 may include multiple availability zones 215. Each of availability zones 215 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 215. For example, a database that is maintained as part of NDC 230 may be replicated across availability zones 215; therefore, if an availability zone of the cloud computing region is unavailable, a copy of the database remains up-to-date and available, thus allowing for continuous or near continuous functionality.

On a (e.g., public) cloud computing platform, cloud computing region 210-1 may include the ability to use a different type of data center or group of data centers, which can be referred to as local zones 220. For instance, a client, such as a provider of the hybrid cloud cellular network, can select from more options of the computing resources that can be reserved at an availability zone 215 compared to a local zone 220. However, a local zone 220 may provide computing resources nearby geographic locations where an availability zone 215 is not available. Therefore, to provide low latency, certain network components, such as regional data centers 240, can be implemented at local zones 220 rather than availability zones 215. In some circumstances, a geographic region can have both a local zone 220 and an availability zone 215.

In the topology of a 5G NR cellular network, 5G core functions of core 139 can logically reside as part of a national data center (NDC) 230. NDC 230 can be understood as having its functionality existing in cloud computing region 210-1 across multiple availability zones 215. At NDC 230, various network functions, such as NFs 232, are executed. For illustrative purposes, each NF 232, whether at NDC 230 or elsewhere located, can be comprised of multiple sub-components, referred to as pods (e.g., pod 211) that are each executed as a separate process by the cloud computing region 210. The illustrated number of pods 211 is merely an example; fewer or greater numbers of pods 211 may be part of the respective 5G core functions. It should be understood that in a real-world implementation, a cellular network core, whether for 5G or some other standard, can include many more network functions. By distributing NFs 232 across availability zones 215, load-balancing, redundancy, and fail-over can be achieved. In local zones 220, multiple regional data centers 240 can be logically present. Each of regional data centers 240 may execute 5G core functions for a different geographic region or group of RAN components. As an example, 5G core components that can be executed within an RDC, such as RDC 240-1, may be: UPFs 250, SMFs 260, and AMFs 270. While instances of UPFs 250 and SMFs 260 may be executed in local zones 220, SMFs 260 may be executed across multiple local zones 220 for redundancy, processing load-balancing, and fail-over.

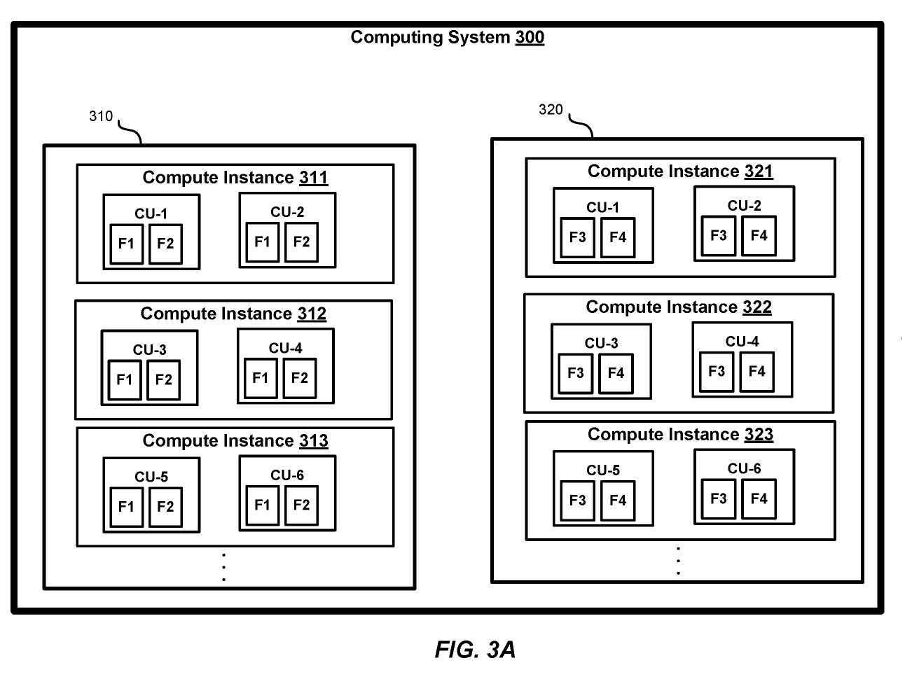

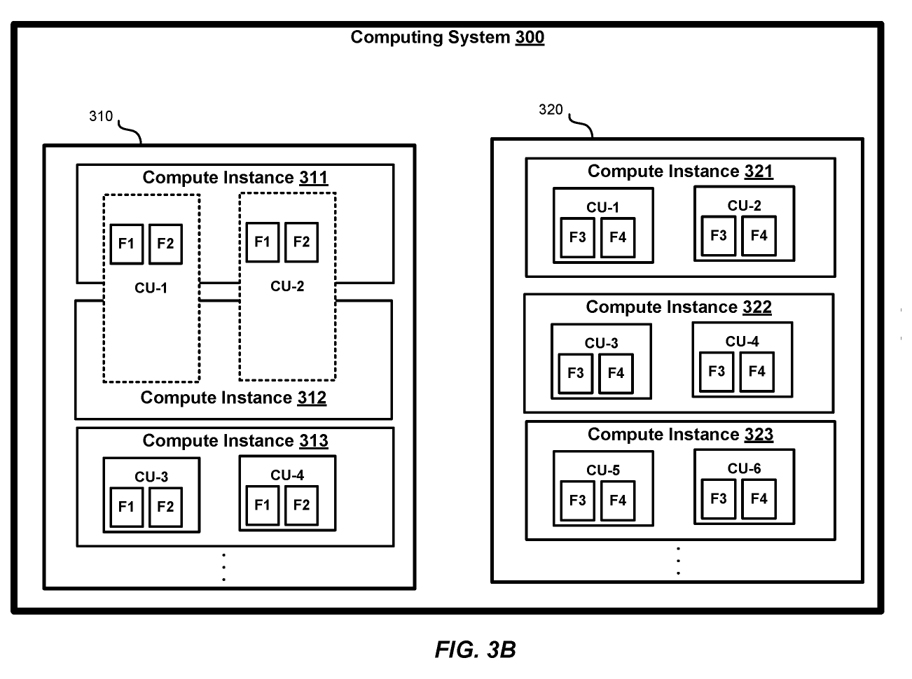

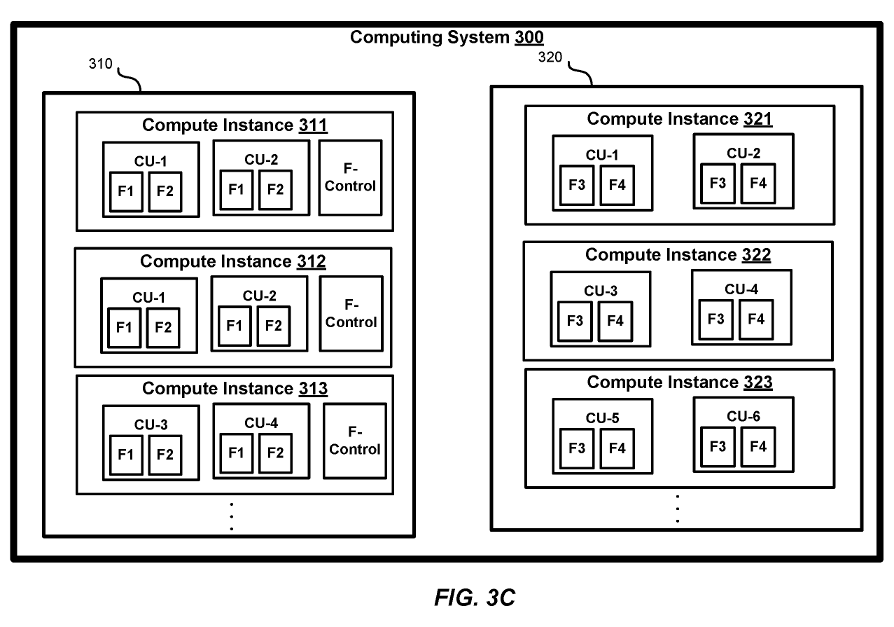

FIGS. 3A-3C describe various embodiments of a computing system 300. As further explained below, network functionality (e.g., of the CU 129 and/or the core 139) may be distributed across the instances instantiated on the computing system 300. By grouping a set of network functions and executing that group of functions on a particular compute instance, various benefits may be achieved. This may include high availability of any network functions. Further, computer resources (e.g., processor speed, capacity, memory, RAM, etc.) to execute a particular function may be dynamically modified by increasing, decreasing, and/or modifying the resources provided to the particular function. Further, additional instances of a particular function may be created to service requests at the computing system 300.

FIG. 3A illustrates the computing system 300, according to certain embodiments. The computing system 300 may be instantiated and/or provisioned on a cloud computing platform (e.g., a private cloud network, a public cloud-based computing platform, a hybrid cloud environment, a physical or virtual bare metal as a service platform, etc.). The computing system 300 may be established with a pre-determined amount of computing resources (e.g., volatile memory, non-volatile memory, processors, cache, etc.). The amount of computing resources may be used to determine the configuration of one or more processes which may be instantiated and/or executed on the computing system 300. Container orchestration systems (e.g., Kubernetes) may be utilized to orchestrate, schedule, instantiate, uninstantiate, modify, configure, scale, deploy, and/or manage the components of computing system 300. The container orchestration system may also determine the ability of software components to communicate with one another. Additionally, other components may be present in the computing system 300, such as a hypervisor, virtual machine operating system, libraries, virtual router, configuration files, schedulers, controller managers, proxy, API manager, etc.

The computing system 300 may contain one or more sets of compute instances, such as a computing set 310 and a computing set 320. The computing sets 310 and 320 may contain one or more compute instances 311-313 and 321-323, respectively. Each of the compute instances in the computing sets 310 and 320 may share a set of characteristics (or properties). For example, each of the compute instances 311-313 may be characterized by a first processor speed and capacity, a first amount of RAM, and other such characteristics. Each of the compute instances 321-323 may be characterized by a second processor speed and capacity, a second amount of RAM, and other such characteristics. In other words, the computing set 310 may be thought of as a collection of one or more virtual machines of a first type, and the computing set 320 may be thought of as a collection of one or more virtual machines of a second type.

The first type may include a relatively high processor speed and capacity. Thus, the compute instances 311-313 may be configured to perform processor-heavy tasks. By contrast, the compute instances 321-323 may be configured to have a high through-put, able to handle many less-processor heavy tasks very quickly.

Each compute instance 311-323 may implement one or more network functions (illustrated as F1, F2, F3, etc.) of a specific centralized unit (CU-1, CU-2, CU-3, etc.). A specific CU may be distributed across the compute instances of the computing sets 310 and 320. For example, CU-1 may be implemented by the compute instances 310 and 320. Tthe network functions F1 and F2 may be processor-heavy network functions, requiring more compute power than other network functions. Thus, the network function F1 and F2 may be implemented by compute instance 311 due to the configuration of the compute instance 311. The network functions F3 and F4, by contrast, may be less processor-intensive, but require faster throughput. Thus, the network functions F3 and F4 may be implemented by the compute instance 312.

Although only two computing sets are shown in FIG. 3A, a person of skill in the art will appreciate that any number of computing sets may be instantiated on the computing system 300. Similarly, while a finite number of compute instances are illustrated in FIG. 3A, a person of skill in the art will appreciate that any countably finite number of compute instances may be instantiated within the respective computing set within the overall computational limits of the computing system 300.

In relation to the other components described above with cellular network system 100, the computing system 300 may provide the functionality of and form a portion of the RAN or the O-RAN. For example, referring back to FIGS. 1A and 1B, the computing system 300 may be used to implement some or all the CU 129 and/or perform one or more functions described above with respect to the CU 129. In the embodiment illustrated in FIG. 3A, the computing system 300 may perform the functions described above with respect to CU 129 and/or the core 139. For example, the computing system 300 may perform the functions described above with respect to network resource management components 150, policy management components 160; subscriber management components 170, packet control components 180, UPF 190, and/or any other such network function.

In some examples, the computing system 300 may be instantiated and/or provided on a computing platform (e.g., a private computing platform, a public cloud-based computing platform, a hybrid cloud environment, a physical or virtual bare metal as a service platform). The computing system 300 may be established with a pre-determined amount of computing resources (e.g., volatile memory, non-volatile memory, processors, cache, etc.). The amount of computing resources may be used to determine the configuration of one or more processes which may be instantiated and/or executed on the computing system 300. Container orchestration systems (e.g., Kubernetes) may be utilized to orchestrate, schedule, instantiate, uninstantiate, modify, configure, scale, deploy, and/or manage the components of computing system 300. The container orchestration system may also determine the ability of software components to communicate with one another.

For example, a first group of network functions may be performed on the computing set 310 and a second group of network resources may be performed on the computing set 320. The specific network resources included within one compute instance may be determined based on known configuration information, performance characteristics/requirements of a 5G network, and/or heuristic information about the network. For example, the computing set 310 may contain processes which require a larger number of processors (e.g., CPUs or other computational units) to execute processor intensive functions. The computing set 320 may contain processes which are less processor intensive but require higher throughput (e.g., a higher number of packets per second). Thus, computing set 320 may instantiate a larger number of compute instances to meet those requirements. This may ensure high availability of resources for incoming requests to the computing system 300.

Network functions which are closely related (i.e., have similar compute resource requirements) may be included within one computing set. The grouping of network functions may be based on properties including processor type, processing speed, memory amount, performance of the function, whether the network function is processor heavy, run time of the function, latency related to executing the function, relation to other network functions and/or 5G network components (e.g., where the function may output a value to), etc.

Network functions which may be required to be executed in proportion to an increase in the number of user equipment connected with the network may be included within one computing set. Similarly, network functions which may be required to be executed in proportion to the overall traffic of the network may be included within another computing set. Thus, as the requirements placed on the 5G network (and in turn on the computing system 300 changes), the resources provided to the computing set 310 and/or computing set 320 may be dynamically adjusted by the computing system 300 to allow for a fewer or higher number of the compute instances on each respective computing set to be instantiated.

The number of compute instances (e.g., compute instances 311–313 and 321–323) executing on computing sets 310 and 320 may be configured and/or determined based on a number of parameters, including the total computing resources of the computing system 300, the number of requests being received by the computing system 300, the properties of each request being received, the priority of a request, the one or more network functions (or group of network functions) which may be included within the computing set. As the compute instances within a computing set may be replicas of one another, the number of compute instances may be increased and/or decreased (e.g., instantiated and uninstantiated) based on the current network requirements and/or requests being received by the computing system 300. The number of compute instances within each respective computing set may be increased and/or decreased independently of compute instances of another computing set. The compute instances may have a fixed and/or preset number of computing resources which they may be provided. Thus, the number of compute instances on a particular computing set may be limited by the resources of that particular computing set at that particular time.

In an example embodiment, the computing set 310 may be used to implement two network functions within each compute instance. The functions may further have microservices associated with them to enable the functions to be performed. For example, each function may be an application, and the associated microservices may be containerized services which may execute independently of one another in a standalone fashion. In some examples, the functions may share one or more microservices. Example microservices may include microservices which may be collecting the telemetry data, providing performance management, fault management, the configuration management, interfacing with one or more 5G network components (e.g., the DU 127), etc.

The compute instance 311 may have instantiate these functions as functions F1 and F2 within a particular CU. The two functions may receive data, execute their respective functions, and provide an output to the computing system 300 and/or other network component(s). In some examples, the functions F1 and F2 may share the resources of the compute instance 311. In other examples, each function may have predetermined resources from the resources of the compute instance 311. Similarly, the compute instance 313 may also have instantiated another copy of the same functions, F1 and F2. The functions instantiated on the compute instance 313 may execute independently of the other functions (e.g., the functions instantiated on the compute instance 311 within CU-1 and/or CU-2).

Some compute instances may be “rollover” compute instances or “overflow”. For example, compute instance 312 may be a rollover instance for compute instance 311 and/or other compute instances within the computing set 310. Compute instance 312 may be assigned as the compute instance for a fixed number of compute instances (e.g., one rollover instance for 5 compute instances) or for a single compute instance. As the compute instance 312 is a rollover instance and/or an overflow instance, upon failure of the compute instance 311, the functionality provided by the compute instance 311 (including any live transmissions, data being processed, and connectivity with a specific RU, antenna array, and one or more user equipment) may be transferred to the compute instance 312. For example, compute instance 311 may fail due to a mechanical, electrical, and/or software failure to the underlying physical hardware (or software platform) on which compute instance 311 is running. Compute instance 312 may have been instantiated prior to failure of the compute instance 311 to ensure that there is no loss of connectivity due to a failure within the computing system 300. In some examples, such as when multiple requests need to be processed by CU-1 and/or CU-2, the compute instance 312 may be used to service those requests.

Turning next to the compute instances 321–323, which may execute functions F3 and F4 as defined by the computing set 320. The compute instance 321 may instantiate a CU-1 and CU-2, which may contain functions F3 and F4. Similarly, the compute instance 322 may instantiate CU-3 and CU-4 which may contain functions F3 and F4. Compute instance 323 may instantiate CU-5 and CU-6, which may contain functions F3 and F4. Although the same label is used, it is to be understood that each compute instance may have a unique instantiation of a CU and the specific function therein. Each CU may further be associated, assigned, and/or in data communication with a specific RU, DU, and/or base station equipment.

While only computing set 310 and computing set 320 are illustrated in FIG. 3A, any number of computing sets may be included. As one example, the network resource management components 150 may be executed on the computing set 310 while the policy management components may be executed on the computing set 320. The respective functions described above with respect to these components (e.g., the Network Repository Function (NRF) 152 and the Network Slice Selection Function (NSSF) 154; the Charging Function (CHF) 162 and the Policy Control Function (PCF) 164) may be executed. Other computing sets may be included in the computing system 300 to provided subscriber management components, packet control components, user plane functions, etc.

During operation of the computing system 300, each compute instance may be responsible for the commands and/or requests received from a particular radio unit(s), antenna array(s), and/or user equipment connected to a particular RU(s). During a failure of a particular compute instance, the rollover compute instance associated with that particular compute instance may take over the functionality for the associated physical units (e.g., radio unit, antenna array, and/or user equipment).

FIG. 3B illustrates an additional embodiment of the computing system 300. The embodiment of the computing system 300 may include a “rollover” of the CU-1 and the CU-2 on the compute instance 311 to the compute instance 312. For example, during an outage and/or malfunction of the compute instance 311, the CU-1 and CU-2 can continue to run on the compute instance 312. As the CU-1 and the CU-2 may have been assigned to a particular set of network components (e.g., RU, DU, etc.), those network components (and user equipment thereby) may continue to access the 5G network and associated functionality without disruption. Upon the compute instance 311 being unavailable, the computing system 300 may direct the compute instance 312 to take over the tasks and functionality provided by the compute instance 311. While only one rollover is illustrated as an example, other compute instances may be instantiated as rollover compute instances.

FIG. 3C illustrates an additional embodiment of the computing system 300. The embodiment of the computing system 300 may include an additional component (illustrated as “F-Control”) configured to provide management and/or control functions in the one or more of the compute instances. The F-control component may be instantiated on each of the compute instances 311–313 or a subset thereof. The F-control component may be responsible for various functionality which may otherwise take place outside of the compute instances, e.g., managed by the computing system 300. As non-limiting examples, the F-control component may provide control elements including control elements software deployment as a service (SDaaS), Telco Cloud Integration Layer (TCIL), and Cloud Range Data Layer (CRDL)) .

The F-control component may further allow for information outputted from a function (e.g., the functions F1, F2, etc.) to be routed to another network component from the compute instance itself. The F-control component may further also manage requests which are being received at the compute instance. The F-control component may allow for improved latency and the reduction of components instantiated to route and/or transmit data to and from network functions.

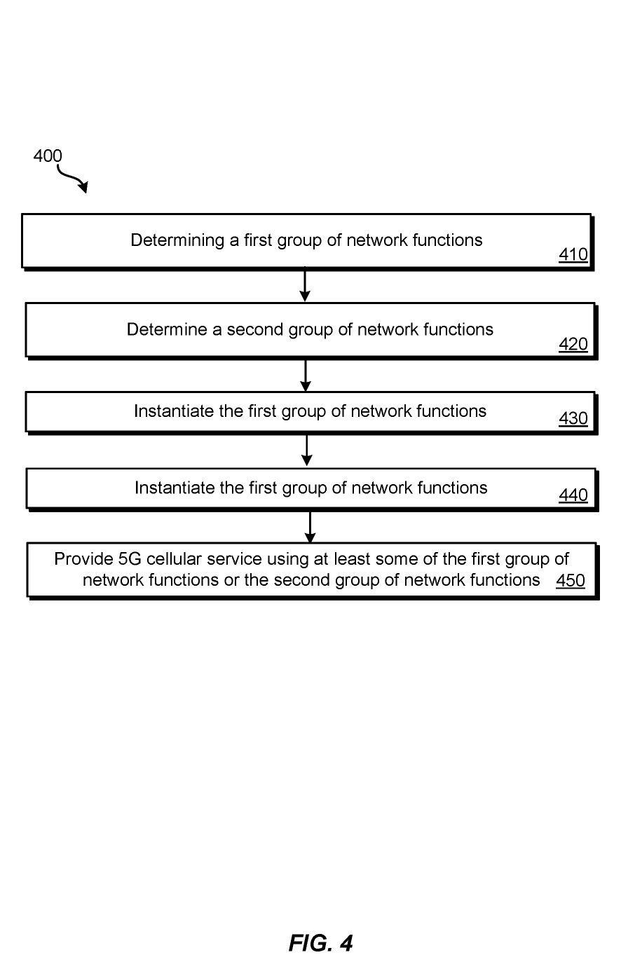

FIG. 4 illustrates a flowchart of a method 400 for detecting objects within an environment, according to certain embodiments. The method 400 may be performed by some or all of the systems and devices described herein. For example, the method 400 may be performed by the systems 100 and/or 200, working alone or in conjunction with each other. The steps of the method 400 may be performed in a different order than is shown and described, and/or some steps may be combined. In some embodiments, some steps may be skipped altogether.

At step 410, the method 400 may include determining a first group of network functions. The first group of network functions may be based on properties of a 5G network and/or the properties of a computing system. For example, the first group of network functions may be functions chosen from functions performed by the CU 129 and the core 139 described above. These functions may include, for example, the Network Repository Function (NRF) 152 and Network Slice Selection Function (NSSF) 154, the Charging Function (CHF) 162, the Policy Control Function (PCF) 164, the Unified Data Management (UDM) 172, the Authentication Server Function (AUSF) 174, the Access and Mobility Management Function (AMF) 182, the Session Management Function (SMF) 184, and the User plane function (UPF) 190. One or more network functions may be included within the first group of network functions. The first group of network functions may also be chosen based on a particular performance requirements and/or requirements to execute those functions. For example, functions which are computationally more intensive may be ranked, and groupings may be determined based on the rank. Functions which are expected to be computationally less intensive but may require low latency (higher throughput) and may be called repeatedly may be grouped together. These groupings may form the basis of where to instantiate the compute instances.

At step 420, the method 400 may include determining a second group of network functions. Similar to the determination of the first group of network functions, the second group of network functions may be based on one or more properties of the computing system, the functions, and/or the 5G cellular network. For example, the second group of network functions may be functions provided by the CU 129 and/or the core 139 which have not been included in the first group of network functions.

At step 430, the method 400 may include instantiating the first group of network functions. The first group of network functions may be instantiated on one or more compute instances within a first computing set. For example, the first group of network functions may be instantiated on compute instance 311 of the computing set 310. The first group of network functions may be instantiated on multiple compute instances. Each compute instance may have multiple sets of the first group of network functions. The first group of network functions may be replicated as additional compute instances are added and/or removed from the computing system. For example, the first group of network functions may be instantiated on a newly added compute instance in response to a demand placed on the computing system 300 above a threshold value.

At step 440, the method 400 may include instantiating the second group of network functions. The second group of network functions may be instantiated on one or more compute instances within a second computing set. For example, the second group of network functions may be instantiated on the compute instance 321 of the computing set 320. Similar to the first set of network functions, the second set of network functions may be instantiated on multiple compute instances. The first set of network functions and the second set of network functions may be related as they collectively may provide the functionality of one or more network components described above (e.g., the core 139, the CU 129, etc.).

At step 450, the method 400 may include providing 5G cellular service to a user equipment using at least some of the first group of network functions and the second group of network functions. The 5G cellular service may include services provided by the cellular network system 100 to any of the UE 110-1 to UE 110-3. As an example, a request to transmit and/or receive data made by the UE 110-1 may require functions included in the CU 129 and/or the core 139. These functions may be present in the first group of network functions and/or the second group of network functions. The request may be routed to the specific instantiated compute instance associated with the UE 110-1. The request may be processed to allow the CU 129 and/or the core 139.

In some examples, Kubernetes or a similar containerized platform may be used. Each compute instance may be associated with a specific CU which may be associated with and/or provide functionality to a specific geographical region, UE, RU, DU, and/or base station equipment.

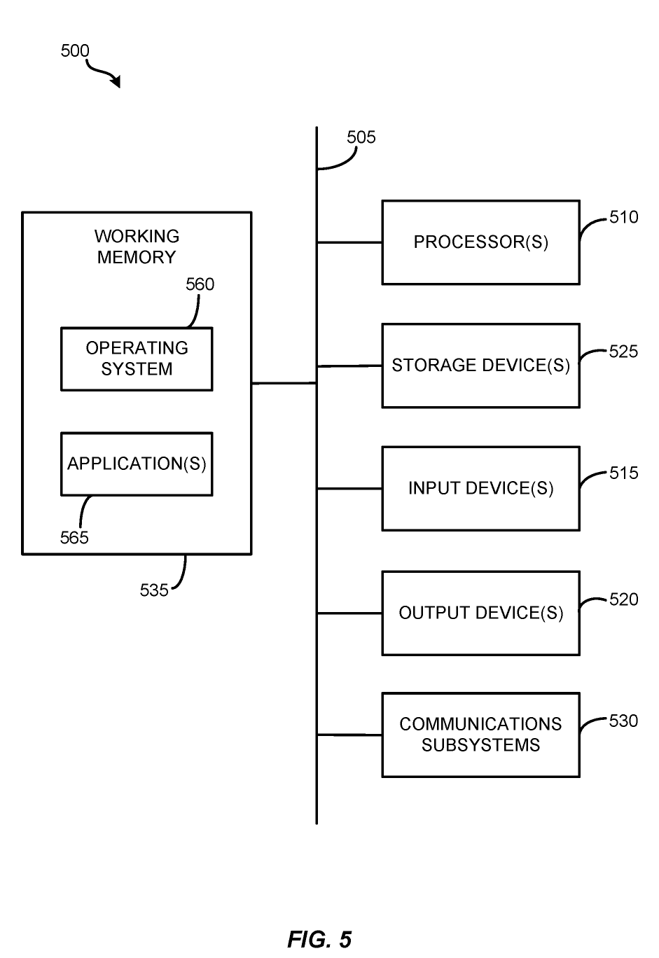

FIG. 5 is a schematic diagram illustrating an example of computer system 500. The computer system 500 is a simplified computer system that can be used to implement various embodiments described and illustrated herein. A computer system 500 as illustrated in FIG. 5 may be incorporated into devices such as a portable electronic device, mobile phone, or other device as described herein. FIG. 5 provides a schematic illustration of one embodiment of a computer system 500 that can perform some or all of the steps of the methods and workflows provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown including hardware elements that can be electrically coupled via a bus 505, or may otherwise be in communication, as appropriate. The hardware elements may include one or more processors 510, including without limitation one or more general-purpose processors and/or one or more special-purpose processors such as digital signal processing chips, graphics acceleration processors, and/or the like; one or more input devices 515, which can include without limitation a mouse, a keyboard, a camera, and/or the like; and one or more output devices 520, which can include without limitation a display device, a printer, and/or the like.

The computer system 500 may further include and/or be in communication with one or more non-transitory storage devices 525, which can include, without limitation, local and/or network accessible storage, and/or can include, without limitation, a disk drive, a drive array, an optical storage device, a solid-state storage device, such as a random access memory ("RAM"), and/or a read-only memory ("ROM"), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 530 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 530. In other embodiments, a portable electronic device, e.g., the first electronic device, may be incorporated into the computer system 500, e.g., an electronic device as an input device 515. In some embodiments, the computer system 500 will further include a working memory 535, which can include a RAM or ROM device, as described above.

The computer system 500 also can include software elements, shown as being currently located within the working memory 535, including an operating system 560, device drivers, executable libraries, and/or other code, such as one or more application programs 565, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 5, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 525 described above. In some cases, the storage medium might be incorporated within a computer system, such as computer system 500. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 500 and/or might take the form of source and/or installable code, which, upon compilation and/or installation on the computer system 500 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 500 to perform methods in accordance with various embodiments of the technology. According to a set of embodiments, some or all of the operations of such methods are performed by the computer system 500 in response to processor 510 executing one or more sequences of one or more instructions, which might be incorporated into the operating system 560 and/or other code, such as an application program 565, contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. Additionally, or alternatively, portions of the methods described herein may be executed through specialized hardware.

The terms "machine-readable medium" and "computer-readable medium," as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 and/or components thereof generally will receive signals, and the bus 505 then might carry the signals and/or the data, instructions, etc. carried by the signals to the working memory 535, from which the processor(s) 510 retrieves and executes the instructions. The instructions received by the working memory 535 may optionally be stored on a non-transitory storage device 525 either before or after execution by the processor(s) 510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms "a", "an", and "the" include plural references unless the context clearly dictates otherwise. Thus, for example, reference to "a user" includes a plurality of such users, and reference to "the processor" includes reference to one or more processors and equivalents thereof known in the art, and so forth.

Also, the words "comprise", "comprising", "contains", "containing", "include", "including", and "includes", when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A computing system comprising:
a first set of compute instances, the first set of compute instances characterized at least in part by a first set of properties;
a second set of compute instances, the second set of compute instances characterized at least in part by a second set of properties;
one or more processors; and
a computer-readable medium comprising instructions that, when executed by the one or more processors, cause the system to:
determine, based at least in part on the first set of properties, a first group of network functions, used to implement a 5G cellular network;
determine, based at least in part on the second set of properties, a second group of network functions used to implement the 5G cellular network;
instantiate the first group of network functions on one or more of the compute instances of the first set of compute instances;
instantiate the second group of network functions on one or more of the compute instances of the second set of compute instances; and
provide 5G cellular service to a user equipment using at least some of the first group of network functions and the second group of network functions.

2. The system of claim 1, wherein the first set of properties and the second set of properties comprise at least one of a processor type, processing speed, or memory amount.

3. The system of claim 1, wherein the first set of compute instances are configured to execute processor-heavy network functions.

4. The system of claim 1, wherein the second set of compute instances are configured to execute high-throughput network functions.

5. The system of claim 1, wherein the first set of compute instances and the second set of compute instances are implemented on a cloud based architecture.

6. The system of claim 1, wherein the 5G cellular network is a standalone cellular network.

7. The system of claim 1, wherein at least one of the first group of network functions or the second group of network functions comprise a control function.

8. The system of claim 1, wherein the first group of network functions further comprises an active function implemented on a first compute instance of the first set of compute instances and a backup function implemented on a second compute instance of the first set of compute instances.

9. A method for providing a 5G cellular network, the method comprising:
determining, based at least in part on a first set of properties, a first group of network functions, used to implement a 5G cellular network;
determining, based at least in part on a second set of properties, a second group of network functions used to implement the 5G cellular network;
instantiating the first group of network functions on one or more of compute instances of a first set of compute instances, the first set of compute instances characterized at least in part by the first set of properties;
instantiating the second group of network functions on one or more of the compute instances of a second set of compute instances, the second set of compute instances characterized at least in part by the second set of properties; and
providing 5G cellular service to a user equipment using at least some of the first group of network functions and the second group of network functions.

10. The method of claim 9, wherein the first set of properties and the second set of properties comprise at least one of a processor type, processing speed, or memory amount.

11. The method of claim 9, wherein the first set of compute instances are configured to execute processor-heavy network functions.

12. The method of claim 9, wherein the second set of compute instances are configured to execute high-throughput network functions.

13. The method of claim 9, wherein the first set of compute instances and the second set of compute instances are implemented on a cloud based architecture.

14. The method of claim 9, wherein the 5G cellular network is a standalone cellular network.

15. The method of claim 9, wherein at least one of the first group of network functions or the second group of network functions comprise a control function.

16. The method of claim 9, wherein the first group of network functions further comprises an active function implemented on a first compute instance of the first set of compute instances and a backup function implemented on a second compute instance of the first set of compute instances.

17. A non-transitory computer-readable medium containing instructions, that when executed by one or more processors, are configured to cause the one or more processors to perform operations comprising:
determining, based at least in part on a first set of properties, a first group of network functions, used to implement a 5G cellular network;
determining, based at least in part on a second set of properties, a second group of network functions used to implement the 5G cellular network;
instantiating the first group of network functions on one or more of compute instances of a first set of compute instances, the first set of compute instances characterized at least in part by the first set of properties;
instantiating the second group of network functions on one or more of the compute instances of a second set of compute instances, the second set of compute instances characterized at least in part by the second set of properties; and
providing 5G cellular service to a user equipment using at least some of the first group of network functions and the second group of network functions.

18. The non-transitory computer-readable medium containing instructions of claim 17, wherein the first set of properties and the second set of properties comprise at least one of a processor type, processing speed, or memory amount.

19. The non-transitory computer-readable medium containing instructions of claim 17, wherein the first set of compute instances are configured to execute processor-heavy network functions.

20. The non-transitory computer-readable medium containing instructions of claim 17, wherein the second set of compute instances are configured to execute high-throughput network functions.
